(19) United States
(12) Patent Application Publication
(10) Pub. No.: US 2009/0116098 A1
(43) Pub. Date: May 7, 2009

(54) Device for adjusting the tint of glass

(76) Inventor: Chia-Jung Chang, Taipei City (TW)

Correspondence Address: Stuart D. Frenkel;Frenkel & Associates, P.C., Suite 330, 3975 University Drive, Fairfax, VA, 22030, US

(21) Appl. No.: 12/154,820

(22) Filed: May 28, 2008

(30) Foreign Application Priority Data
Nov. 6, 2007 (TW) 096218694

(51) Int. Cl. G02F 1/153

(52) U.S. Cl. 359/275

(57) ABSTRACT

A device for adjusting the tint of glass includes an electrochromic light-filter film, a light sensor, and a control unit provided on a light-pervious structure, such as a glass. When the light sensor senses the glass is irradiated by light and sends a signal to the control unit, the control unit sends out a control signal to a power supply, provided the sensed light has an intensity exceeded a preset value, so that the power supply applies a voltage to the electrochromic light-filter film for the same to produce changes in the tint thereof and thereby achieve the effect of isolating strong light and shielding sunlight.

### FIELD OF THE INVENTION

The present invention relates to an adjusting device, and more particularly to a device for adjusting the tint of glass by mounting an electrochromic light-filter film (such as a film of electrochromic devices, suspended particle devices, polymer dispersed liquid crystal devices etc.) on a glass, so as to achieve the effect of isolating strong light and shielding sunlight.

### BACKGROUND OF THE INVENTION

The conventional sun shielding or heat insulating devices for automobile window glass generally includes visors, sunshades, and window films, which are normally installed on the windshield glass, door window glass, skylight glass, and rear window glass to shielding sunlight or insulate heat.

The sunshades will form a hindrance to the driver's sight, and therefore could not be installed on the windshield glass. The visors also tend to block the driver's sight, so that the driver has to adjust his or her sight now and then to watch road and traffic condition. Besides, the visors do not allow too much adjustment in their size and mounting position. As to the conventional window glass coatings or tinted window films, they have fixed tint that does not provide the driver with any sun-shielding or heat insulating effect.

### SUMMARY OF THE INVENTION

A primary object of the present invention is to provide a device for adjusting the tint of glass, of which an electrochromic light-filter film (such as a film of electrochromic devices, suspended particle devices, polymer dispersed liquid crystal devices etc.) mounted on a piece of glass may be automatically or manually controlled to produce changes in the tint thereof, so as to achieve the effect of isolating strong light and shielding sunlight in response to light intensity irradiated on the glass.

To achieve the above and other objects, the device for adjusting the tint of glass according to the present invention includes:

an electrochromic light-filter film, which is mounted on a windshield glass to produce different tints in response to different voltages applied thereto;

a light sensor being electrically connected to the electrochromic light-filter film for sensing light irradiated on the electrochromic light-filter film, and outputting a signal corresponding to an intensity of the sensed light; and

a control unit being electrically connected to the light sensor and the electrochromic light-filter film for receiving the signal from the light sensor, and determining whether the intensity of the sensed light exceeds a preset value; the control unit sending a control signal to a power supply when it is determined the intensity of the sensed light exceeds the preset value; the power supply being electrically coupled with the light sensor and the electrochromic light-filter film, and applying a voltage to the electrochromic light-filter film when the power supply receives the control signal from the control unit, causing the electrochromic light-filter film to produce changes in tint in response to the voltage applied thereto.

Therefore, by using the electrochromic light-filter film to enable adjustment of the tint of glass, it is able to improve the conventional sun shielding or heat insulating devices and provide enhanced effect of isolating strong light and shielding sunlight.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of the present invention;

FIG. 2 shows a control knob included in the device of the present invention;

FIG. 3 shows an electrochromic light-filter film included in the device of the present invention is tinted at two trapezoidal areas on a windshield glass corresponding to a front seat and a driver seat;

FIG. 4 shows the electrochromic light-filter film included in the device of the present invention is tinted at two semicircular areas on the windshield glass corresponding to a front seat and a driver seat;

FIG. 5 shows the electrochromic light-filter film included in the device of the present invention is tinted in gradient on the entire windshield glass to show a plurality of transverse striped areas;

FIG. 6 shows the electrochromic light-filter film included in the device of the present invention is tinted at two block-shaped areas on the windshield glass corresponding to two visors on a car, so as to replace the opaque visors; and

FIG. 7 shows a plurality of control keys that may be used in the present invention to replace the control knob shown in FIG. 2.

### DETAILED DESCRIPTION OF THE PREFERRED EMBODIMENTS

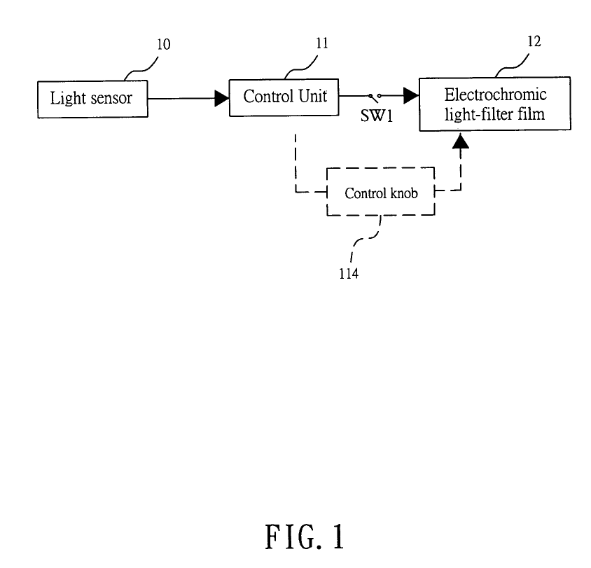

Please refer to FIG. 1. A device for adjusting the tint of glass according to the present invention may be mounted to a windshield glass, for example, and includes a light sensor 10, a control unit 11, and an electrochromic light-filter film 12.

The electrochromic light-filter film 12 (such as a film of electrochromic devices, suspended particle devices, polymer dispersed liquid crystal devices etc.) is a colorless tint-producing material that can be switched among different tints by changing the arrangement of suspended particulates in the material to control the amount of light allowed to pass through the material.

The light sensor 10 is electrically connected to the electrochromic light-filter film 12 for sensing the intensity of light irradiated on the electrochromic light-filter film 12, and outputs a signal corresponding to the sensed light intensity for the electrochromic light-filter film 12 to occur stepped change in its tint in response to the light intensity. The light sensor 10 may be installed in a car at different places, such as the rearview mirror, an upper portion of the windshield glass, and lower portions of door windows.

The control unit 11 is electrically connected to the light sensor 10 and the electrochromic light-filter film 12 for receiving the signal output by the light sensor 10, and determines whether the received signal indicates a light intensity exceeded a preset value. When the received signal indicates a light intensity exceeded the preset value, the control unit 11 sends a control signal to a power supply that is electrically coupled with the light sensor 10 and the electrochromic light-filter film 12, so that the power supply applies a voltage to the electrochromic light-filter film 12. Alternatively, a user may select to manually operate the control unit 11 to apply a voltage to the electrochromic light-filter film 12. As a property thereof, the electrochromic light-filter film 12 changes its tint when the voltage is applied thereto. The control unit 11 may be a clear soft flat cable for mounting to the upper and/or lower portion of the windshield glass.

By the term of “electrochromic”, it means a process in which an electrochromic material is switched from an original transparent colorless state to a colored state when a voltage difference is applied thereto, and then switched from the colored state back to the colorless state when the voltage direction is reversed.

In other words, when the light sensor 10 senses any light, it outputs a signal corresponding to the sensed light intensity to the control unit 11. When it is determined by the control unit 11 the light intensity does not exceed a preset value, no voltage will be applied to the electrochromic light-filter film 12, so that the electrochromic light-filter film 12 is in a natural state without any change in its tint. At this point, the electrochromic light-filter film 12 is not switched between different tints in any mode.

On the other hand, when the light sensor 10 senses any light and outputs a signal to the control unit 11, and the control unit 11 determines the light intensity indicated by the received signal exceeds the preset value, the control unit 11 will send a control signal to a power supply (not shown), which is electrically coupled with the light sensor 10 and the electrochromic light-filter film 12, so that the power supply applies a voltage to the electrochromic light-filter film 12 to cause changes in the arrangement of suspended particulates in the electrochromic light-filter film 12.

The changes in the arrangement of the suspended particulates will cause the electrochromic light-filter film 12 to change its light transmissivity, so that incident light is filtered by the electrochromic light-filter film 12 when passing the same. Since the tint of the electrochromic light-filter film 12 may be steplessly changed within a very short time, the electrochromic light-filter film 12 is able to automatically filter strong light or be manually controlled by a driver to filter light properly according to the driver's need. In either way, the device of the present invention effectively protects the driver and/or other passenger(s) from glaring light.

The device of the present invention allows both automatic and manually caused change in the tint of the electrochromic light-filter film 12 and accordingly the glass with the film 12 mounted thereto, and therefore overcomes the drawbacks in the conventional automobile visors or window films to provide enhanced sunlight blocking and anti-glare effect, making driving safer and more comfortable.

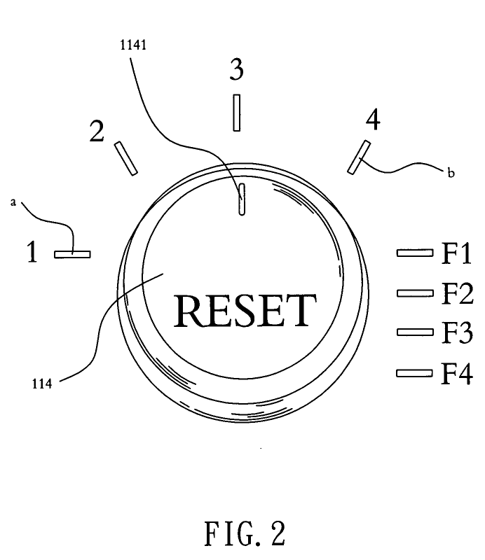

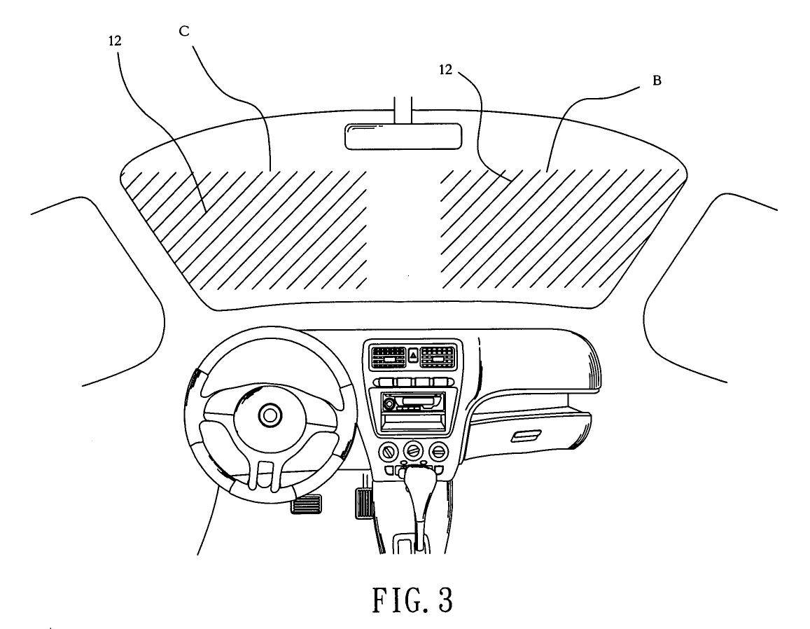

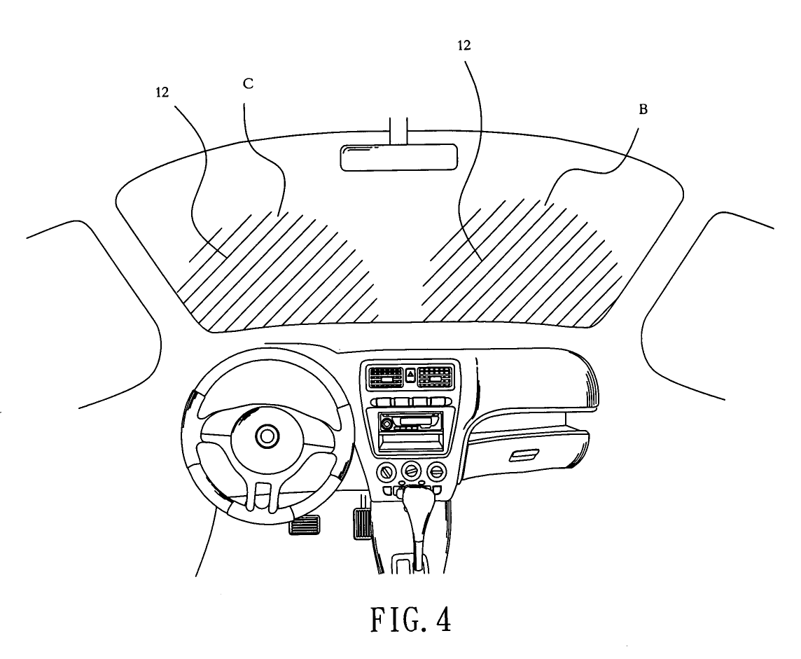

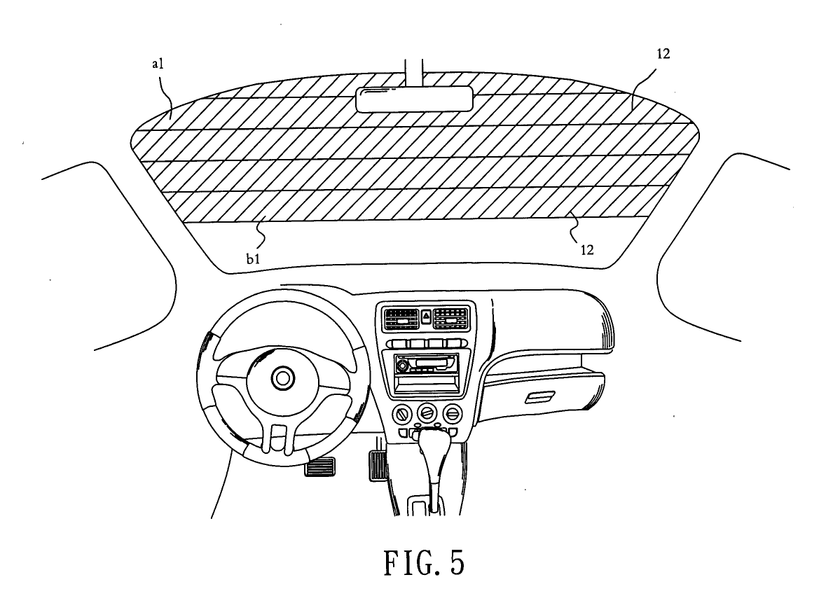

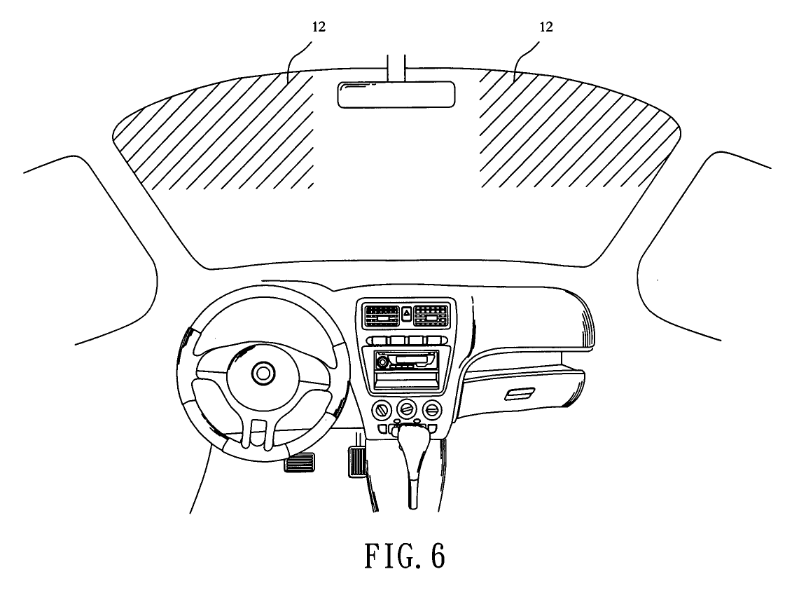

Please refer to FIG. 1 along with FIGS. 2 to 7. The present invention further includes a switch SW1 installed between the electrochromic light-filter film 12 and the control unit 11. The driver may manually operate the switch SW1 to turn on or off the automatic light filtering function of the electrochromic light-filter film 12. By turning the switch SW1 to on, the driver may manually set the operation of the electrochromic light-filter film 12 via a control knob 114. The control knob 114 is provided on a top thereof with a mark 1141, allowing the driver to manually operate the control knob 114 to set different operating modes for the electrochromic light-filter film 12 as below:
(1) When the control knob 114 is turned to align the mark 1141 with a graduation F2, the tinted electrochromic light-filter film 12 will be presented on the windshield glass in two trapezoidal areas (B) and (C) corresponding to the front seat and the driver seat, respectively, as indicated by the oblique lines in FIG. 3.
(2) When the control knob 114 is turned to align the mark 1141 with a graduation F3, the tinted electrochromic light-filter film 12 will be presented on the windshield glass in two semi-circular areas (B) and (C) corresponding to the front seat and the driver seat, respectively, as indicated by the oblique lines in FIG. 4.
(3) The control knob 114 may-be turned to align the mark 1141 with any one of four graduations 1, 2, 3, and 4. When the mark 1141 is aligned with the graduation 1, the electrochromic light-filter film 12 has the darkest tint a1; and when the mark 1141 is aligned with the graduation 4, the electrochromic light-filter film 12 has the lightest tint b1. When the mark 1141 is aligned with the graduation F4, the tint of the electrochromic light-filter film 12 may change in gradient from the darkest to the lightest tint and presented on the entire windshield glass, as indicated by the oblique lines in FIG. 5. That is, the electrochromic light-filter film 12 will show different tints to present a plurality of transverse striped areas on the windshield glass, and the tints of these transverse striped areas are changed in gradient from the upper darkest tint to the lower lightest tint.
(4) Please refer to FIGS. 2 and 6. When the mark 1141 is aligned with the graduation F1, the tinted electrochromic light-filter film 12 will be presented on the windshield glass in two block-shaped areas corresponding to the two visors on the car, as indicated by the oblique lines in FIG. 6. Thus, the electrochromic light-filter film 12 may replace the opaque visors.
(5) Please refer to FIG. 2. When the control knob 114 is pushed, the previous setting is reset to zero.
(6) Please refer to FIG. 2. When the control knob 114 is pulled, other operating modes may be shown.

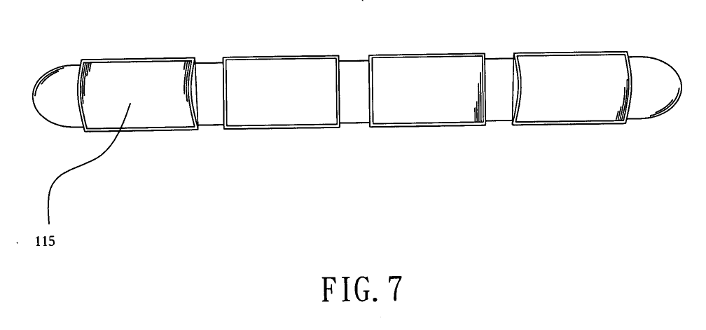

The control knob 114 as shown in FIG. 2 may also be replaced with one or more control keys 115, as shown in FIG. 7. And, the driver may operate the control keys 115 to achieve the effects the same as that obtainable through the control knob 114.

According to the above description, the present invention may provide the following advantages and effects:
a. When the windshield glass is subject to strong sunlight, the light sensor will immediately sense the sunlight and the electrochromic light-filter film is caused to automatically filter the light and change to a darker tint at the area being irradiated by the strong sunlight.
b. When the area being irradiated by the sunlight gradually expands, the electrochromic light-filter film will synchronously automatically adjust to increase the tinted area thereof.
c. The electrochromic light-filter film will instantaneously automatically restore to the original transparent state when the windshield glass is no longer subject to the sunlight.
d. When driving at night or in the dark, there are times the driver's vision is dangerously affected by the glaring light of a car from the opposite side. At this point, the light sensor will detect the glaring light and the area of the electrochromic light-filter film corresponding to the driver seat will automatically adjust to a darker tint to shield the glaring light. And, when the opposite car leaves, the tinted area of the electrochromic light-filter film will instantaneously automatically restore to the original transparent state.

In addition to the above-described automatic sensing and operating modes, the present invention also allows the driver to manually set it to different operating modes via the control knob or other control keys. For example:
(a) The driver may use the control knob or control keys to set the electrochromic light-filter film to show different tints at different areas thereof. That is, the driver may select for the electrochromic light-filter film to change its tint in only one single area or at least two areas, so that different tints varied in gradient may be obtained.
(b) The driver may use the control knob or control keys to adjust the tint of the electrochromic light-filter film.
(c) The driver may use the control knob or control keys for the electrochromic light-filter film to become tinted only at the areas corresponding to the two visors in the car, so as to achieve the effect of shielding light without blocking the driver's sight.

What is claimed is:

1. A device for adjusting the tint of glass, comprising: an electrochromic light-filter film (, such as a film of electrochromic devices, suspended particle devices, polymer dispersed liquid crystal devices etc.) being mounted on a windshield glass to produce different tints in response to different voltages applied thereto;
a light sensor being electrically connected to the electrochromic light-filter film for sensing light irradiated on the electrochromic light-filter film, and outputting a signal corresponding to an intensity of the sensed light; and
a control unit being electrically connected to the light sensor and the electrochromic light-filter film for receiving the signal from the light sensor, and determining whether the intensity of the sensed light exceeds a preset value; the control unit sending a control signal to a power supply when it is determined the intensity of the sensed light exceeds the preset value; the power supply being electrically coupled with the light sensor and the electrochromic light-filter film, and applying a voltage to the electrochromic light-filter film when the power supply receives the control signal from the control unit, causing the electrochromic light-filter film to change in tint in response to the voltage applied thereto.

2. The device for adjusting the tint of glass as claimed in claim 1, wherein the windshield glass includes an area corresponding to a driver seat, an area corresponding to a front seat next to the driver seat, and at least two visor areas; whereby when the light sensor senses a strong light source in front of the windshield glass, the electrochromic light-filter film is caused to change its tint at the areas corresponding to the driver seat and the front seat; and when the intensity of the light source decreases or when the light source vanishes, the electrochromic light-filter film automatically restores to an original transparent state; and wherein the areas corresponding to the driver seat and the front seat may have a shape selected from the group consisting of a trapezoidal shape and a semi-circular shape.

3. The device for adjusting the tint of glass as claimed in claim 2, wherein the at least two visor areas are two block-shaped areas.

4. The device for adjusting the tint of glass as claimed in claim 1, wherein the electrochromic light-filter film follows the intensity and incidence angle of light irradiated thereon to show different tints on the windshield glass in a plurality of transverse striped areas, and the tints in these striped areas change in gradient.

5. The device for adjusting the tint of glass as claimed in claim 1, further comprising a switch installed between the electrochromic light-filter film and the control unit, allowing a driver to turn on or turn off the automatic light filtering function of the electrochromic light-filter film by operating the switch.

6. The device for adjusting the tint of glass as claimed in claim 5, wherein when the switch is turned on, the electrochromic light-filter film may be manually set to adjust the tint thereof by the driver via at least one control knob.

7. The device for adjusting the tint of glass as claimed in claim 6, wherein the control knob is replaced with at least one control key.
